(19) United States
(12) Patent Application Publication
(10) Pub. No.: US 2024/0308078 A1
(43) Pub. Date: Sep. 19, 2024

(54) METHOD AND ELECTRONIC DEVICE FOR CALIBRATING ROBOT

(71) Applicant: ABB SCHWEIZ AG, Baden (CH)

(72) Inventors: Kun Chang, Shanghai (CN); Hao Gu, Shanghai (CN); Lei Mao, Shanghai (CN)

(21) Appl. No.: 18/576,694

(22) PCT Filed: Sep. 22, 2021
(86) PCT No.: PCT/CN2021/119684

§ 371 Date: Jan. 4, 2024

(51) Int. Cl. B25J 9/16; B25J 13/08

(52) U.S. Cl. CPC B25J 9/1692; B25J 9/1653; B25J 13/089

(57) ABSTRACT

A method and an electronic device for calibrating a robot. The method includes obtaining at least two sets of positional data of a first reference point in a base coordinate system of the robot, the first reference point fixedly arranged on the external axis, the at least two sets of positional data corresponding to at least two positions of the first reference point during movement of the external axis. The method includes determining a transformation relationship between the base coordinate system and an user coordinate system of the external axis according to the at least two sets of positional data, determining the calibrated user coordinate system based on the base coordinate system and the transformation relationship, and controlling the robot to process an object arranged on the external axis under the calibrated user coordinate system.

### FIELD

Embodiments of the present disclosure generally relate to a robot, and more specifically, to a method and an electronic device for calibrating a robot.

### BACKGROUND

An industrial robot is an automatically controlled, reprogrammable, multipurpose manipulator programmable in three or more axes. Typical applications of industrial robots include welding, painting, ironing, assembly, pick and place, palletizing, product inspection, and testing, all accomplished with high endurance, speed, and precision.

An auxiliary or external axis is any extra mechanism which is added to a robot cell to add extraDegrees of Freedom and/or extend the robot's range of motion. They can either be attached to the robot itself or to the workpiece. There are various benefits to using external axes, including increased flexibility, the ability to work on larger workpieces, and access to previously unreachable areas of the workspace. An extra benefit can also be reduced cost—in some cases it can be cheaper to use a smaller robot with an auxiliary axis than to invest in a larger robot.

In modern robot systems, all the positions in a robot program are typically stored in Cartesian coordinates (e.g., xyz values for a position) related to a defined coordinate system (or frame). This coordinate system may be related to another coordinate system in a chain. When the external axis is initially used in a robot system or its position has changed relative to the robot system, a chain between the coordinate system of the robot and the coordinate system of the external axis, i.e., the coordinate system of the external axis needs to be calibrated relative to the coordinate system of the robot.

### SUMMARY

Embodiments of the present disclosure provide a method and an electronic device for calibrating and manipulating a robot.

In a first aspect, a method of manipulating a robot is provided. The method comprises obtaining at least two sets of positional data of a first reference point in a base coordinate system of the robot, the first reference point fixedly arranged on the external axis, the at least two sets of positional data corresponding to at least two positions of the first reference point during movement of the external axis: determining a transformation relationship between the base coordinate system and an user coordinate system of the external axis according to the at least two sets of positional data: determining the calibrated user coordinate system based on the base coordinate system and the transformation relationship; and controlling the robot to process an object arranged on the external axis under the calibrated user coordinate system.

With the method according to embodiments of the present disclosure, the external axis can be calibrated automatically. In comparison to the processes of calibration by the operator, errors caused by human factors are eliminated, which can significantly improve the reliability of calibration. Furthermore, the calibration result can be automatically recorded in the memory and may also be transmitted to other external devices in the Internet of Things in a wired or wireless manner, so as to be used by these external devices to help improve the operability and accuracy of the robotic processing system including the robot and one or more external axes.

In some embodiments, obtaining the at least two sets of positional data comprises obtaining a first set of positional data of the first reference point with a sensor arranged on the robot when the first reference point is at an original position; and obtaining at least one set of positional data of the first reference point corresponding to at least two moving positions of the first reference point during the movement of the external axis.

In some embodiments, determining the transformation relationship comprises determining a reference line by fitting the at least two sets of positional data of a first reference point; and determining the transformation relationship according to the reference line and the base coordinate system. In this way, the calibration can be performed in an easier way.

In some embodiments, the method further comprises comprising determining deviations between the at least two sets of positional data of a first reference point and the reference line; and determining an error range of calibration according to the determined deviations. This error range can then be used to make decisions. For example, when it is determined that the determined error range, which can be determined by some analysis, is caused by the error of the external axis, the operator can maintain or replace the external axis according to the error range to improve the accuracy of workpiece machined with the external shaft.

In some embodiments, determining the transformation relationship further comprises obtaining at least two sets of positional data of a second reference point fixedly arranged on the external axis in the base coordinate system, the at least two sets of positional data corresponding to at least two positions of the second reference point during movement of the external axis: determining a positional relationship between the first reference point and the second reference point in the user coordinate system; and determining the transformation relationship according to the positional relationship, the at least two sets of positional data of the first reference point and the at least two sets of positional data of the second reference point. In this way, the external axis can be calibrated more accurately. Furthermore, with more than one reference point being used, each reference point can independently participate in the calibration process described above. The calibration process and results, i.e., the transformation relationships and/or the error ranges, using these reference points can be mutually verified to improve the reliability of the calibration.

In some embodiments, obtaining the at least two sets of positional data further comprises obtaining a plurality sets of surface data corresponding to a plurality of points on a surface of a reference object where the reference point is located: determining a reference shape by fitting the plurality sets of surface data; and obtaining one of the at least two sets of positional data according to the determined reference shape.

In some embodiments, the reference object comprises at least one of a ball, a cylinder, a hole or polyhedron formed on or fixedly arranged on the external axis.

In some embodiments, the external axis comprises at least one of a translational worktable or a turntable, or a combination thereof.

In a second aspect, an electronic device is provided. The electronic device comprises at least one processing unit; and at least one memory coupled to the at least one processing unit and storing instructions which, when executed by the at least one processing unit, causing the at least one processing unit to: obtain at least two sets of positional data of a first reference point in a base coordinate system of the robot, the first reference point fixedly arranged on the external axis, the at least two sets of positional data corresponding to at least two positions of the first reference point during movement of the external axis: determine a transformation relationship between the base coordinate system and an user coordinate system of the external axis according to the at least two sets of positional data: determine the calibrated user coordinate system based on the base coordinate system and the transformation relationship; and control the robot to process an object arranged on the external axis under the calibrated user coordinate system.

In some embodiments, the at least one processing unit is further configured to obtain a first set of positional data of the first reference point with a sensor arranged on the robot when the first reference point is at an original position; and obtain at least one set of positional data of the first reference point corresponding to at least two moving positions of the first reference point during the movement of the external axis.

In some embodiments, the at least one processing unit is further configured to determine a reference line by fitting the at least two sets of positional data of a first reference point; and determine the transformation relationship according to the reference line and the base coordinate system.

In some embodiments, the at least one processing unit is further configured to determine deviations between the at least two sets of positional data of a first reference point and the reference line; and determine an error range of calibration according to the determined deviations.

In some embodiments, the at least one processing unit is further configured to obtain at least two sets of positional data of a second reference point fixedly arranged on the external axis in the base coordinate system, the at least two sets of positional data corresponding to at least two positions of the second reference point during movement of the external axis: determine a positional relationship between the first reference point and the second reference point in the user coordinate system; and determine the transformation relationship according to the positional relationship, the at least two sets of positional data of the first reference point and the at least two sets of positional data of the second reference point.

In some embodiments, the at least one processing unit is further configured to obtain a plurality sets of surface data corresponding to a plurality of points on a surface of a reference object where the reference point is located: determine a reference shape by fitting the plurality sets of surface data; and obtain one of the at least two sets of positional data according to the determined reference shape.

In some embodiments, the reference object comprises at least one of a ball, a cylinder, a hole or polyhedron formed on or fixedly arranged on the external axis.

In some embodiments, the external axis comprises at least one of a translational worktable or a turntable, or a combination thereof.

In a third aspect, a computer readable storage medium is provided. The computer readable storage medium has computer readable program instructions stored thereon which, when executed by a processing unit, cause the processing unit to perform the method as mentioned in the above first aspect.

It is to be understood that the Summary is not intended to identify key or essential features of embodiments of the present disclosure, nor is it intended to be used to limit the scope of the present disclosure. Other features of the present disclosure will become easily comprehensible through the description below.

### BRIEF DESCRIPTION OF THE DRAWINGS

The above and other objectives, features and advantages of the present disclosure will become more apparent through more detailed depiction of example embodiments of the present disclosure in conjunction with the accompanying drawings, wherein in the example embodiments of the present disclosure, same reference numerals usually represent the same components.

FIG. 1 shows a schematic diagram of using a robot to automatically calibrate an external axis according to embodiments of the present disclosure;

FIG. 2 shows a flowchart illustrating a method of manipulating a robot according to embodiments of the present disclosure:

FIGS. 3 and 4 show perspective views of a translation worktable during the calibration according to embodiments of the present disclosure:

FIGS. 5 and 6 show perspective views of a turntable during the calibration according to embodiments of the present disclosure:

FIG. 7 shows a schematic diagram of using a robot to automatically calibrate a positioner according to embodiments of the present disclosure; and

FIG. 8 shows a block diagram of an example computing system/device suitable for implementing example embodiments of the present disclosure.

Throughout the drawings, the same or similar reference symbols are used to indicate the same or similar elements.

### DETAILED DESCRIPTION

The present disclosure will now be discussed with reference to several example embodiments. It is to be understood these embodiments are discussed only for the purpose of enabling those skilled persons in the art to better understand and thus implement the present disclosure, rather than suggesting any limitations on the scope of the subject matter.

As used herein, the term “comprises” and its variants are to be read as open terms that mean “comprises, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be comprised below. A definition of a term is consistent throughout the description unless the context clearly indicates otherwise.

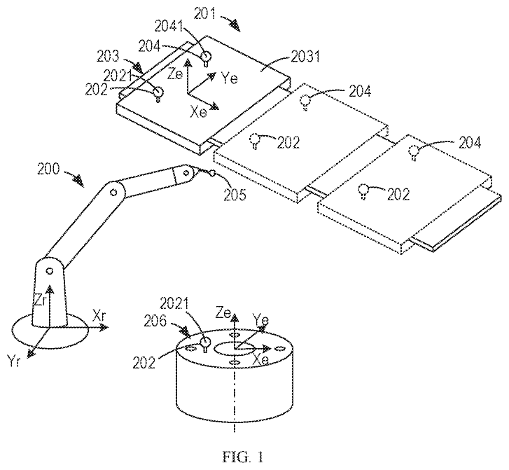

In the industrial applications, external axes typically represent various mechanical worktables of equipment. Translational worktables 203, which belong to a basic type of external axis, are designed to extend the robot's working area of translation that enables the same robot 200 to serve in various work positions, such as the robots 200 on the assembly lines. A turntable 206 is another basic type of external axis 201 that can provide a working platform with additional rotational freedom for the robot 200. FIG. 1 shows these two basic types of external axes. A further typical external axis 201 is a positioner that permits fully coordinated movements, including displacement and rotation. The positioner is typically a combination of one or more basic external axes, i.e., translational worktables 203 and/or turntables 206.

Although the robots 200 have very good mechanical characteristics, their internal coordinate systems are complex. Therefore, the conversion of the internal coordinate systems of the robot 200, the coordinate system for optical design, and the coordinate system for actual processing are very important. It is also one of the key factors for industrial robots 200 to be used in high-precision optical polishing. For an industrial robot 200, its internal coordinate systems include the base coordinate system, the world coordinate system, the user coordinate system, the object coordinate system, and the tool coordinate system, etc. All these coordinate systems follow the right-hand law:

The base coordinate system is typically defined on the main robot 200 mounting-flange. Its origin is typically the projection of the axis of rotation of the first axis onto the plane of the robot 200 base, which defined as XOY. The world coordinate system may coincide with the base coordinate system.

For process-users, the coordinate system of the worktable such as an external axis 201 is typically used as a reference for programming. The coordinate system of the worktable is typically named as the user coordinate system.

Usually there is a chain to associate these coordinate systems. When the robot 200 is moving to a programmed position, the aim is to bring the tool (tool frame) to coincide with the programmed position to close the chain.

When external axes 201 are initially used in a robot system or their positions have changed relative to the robot 200, a chain at least between the base coordinate system and the user coordinate system of the external axis 201 needs to be established. That is, the user coordinate system of the external axis 201 needs to be calibrated relative to the base coordinate system of the robot 200. Although its coordinate system is referred to as the user coordinate system, it does not mean that it can only be used as a worktable to arrange a workpiece. It should be understood that, in addition to being attached to a workpiece as a worktable, the external axis mentioned in the present disclosure can also be attached to the robot base or the end effector of the robot. In the followings, the concept of the present disclosure will be discussed by taking the external axis being used as a worktable as an example. It should be understood that other situations are also similar, and will not be described separately in the following.

In the conventional solutions, the user coordinate system of the external axis 201 is usually calibrated manually by an operator. It is time-consuming and laborious with unsatisfactory calibration effect. In addition, the accuracy of the calibration completely depends on the operation of the operator. Therefore, when the coordinate system is calibrated by different operators, it is difficult to ensure the consistency of the calibration. In addition, the traditional calibration process requires the operator to have rich experience and background knowledge, which is a challenge to the personnel cost of the enterprise.

In order to at least partially address the above and other potential problems, embodiments of the present disclosure provide a method of automatically calibrating an external axis 201 relative to a robot 200. The method can be performed by at least one processing unit of the robot 200 for example by programming the method into instructions stored in at least one memory. Of course, the method may also be performed by any dedicated processor independent of the processing unit of the robot 200. In the followings, the concept of the present disclosure will be discussed by taking the method being performed by the processing unit of the robot 200 as an example. It should be understood that other situations are also similar, and will not be described separately in the following.

To perform the method, the robot 200 may be an industrial robot 200 with multiple joints and a plurality of degrees of freedom, for example, 6 degrees of freedom, as shown in FIG. 1. The robot 200 may comprise at least one end effector adapted to process an object or a workpiece arranged on the external axis 201. The robot 200 may further comprise a sensor 205 for example arranged on an end or the end effector of the robot 200 to facilitate performing of the method according to embodiments of the present disclosure. Examples of the sensor 205 may comprise a touch probe or an electrode ball. The electrode ball may be used to determine a position of an electrically conductive object when it contacts the surface of the object.

It is to be understood that the above examples showing that the sensor 205 comprises a touch probe or an electrode ball are merely illustrative, without suggesting any limitation as to the scope of the present disclosure. Any other suitable sensor 205 is also possible. For example, in some embodiments, alternatively or additionally, the sensor 205 may further comprise a video sensor 205 such as a camera. In the following, the concept of the present disclosure will be discussed by taking the touch probe acting as the sensor 205 as an example. It should be understood that other situations are also similar, and will not be described separately in the following. Before performing the method according to embodiments of the present disclosure, the chains between the base coordinate system of the robot 200 and other coordinate system such as a sensor coordinate system of the sensor 205 have been established.

Moreover, in some embodiments, the sensor 205 may also be arranged on the external axis 201. For example, a touch probe may also be arranged at predetermined position on the external axis 201. In this event, the robot 200 holds a measured object, for example, a ball or a cube, etc., to touch the touch probe to thereby obtain the positional data of the touch probe in the base coordinate system. In the following, the concept of the present disclosure will be discussed by taking the sensor 205 arranged at ten end of the robot 200 as an example. It should be understood that other situations are also similar, and will not be described separately in the following.

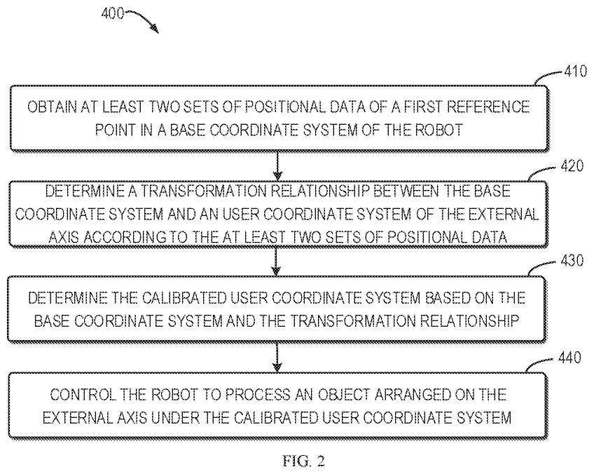

FIG. 2 shows a flowchart of the method of calibrating an external axis 201 relative to a robot 200 according to embodiments of the present disclosure. As shown in FIG. 2, in block 410, at least two sets of positional data of a first reference point 2021 in a base coordinate system are obtained. The first reference point 2021 is fixed arranged on the external axis 201. For example, in some embodiments, the reference point may be a centroid of a reference object (referred to as a first reference object 202) fixed arranged or formed on the external axis 201. Furthermore, a set of positional data may be the three-coordinate value of the corresponding point in the base coordinate system.

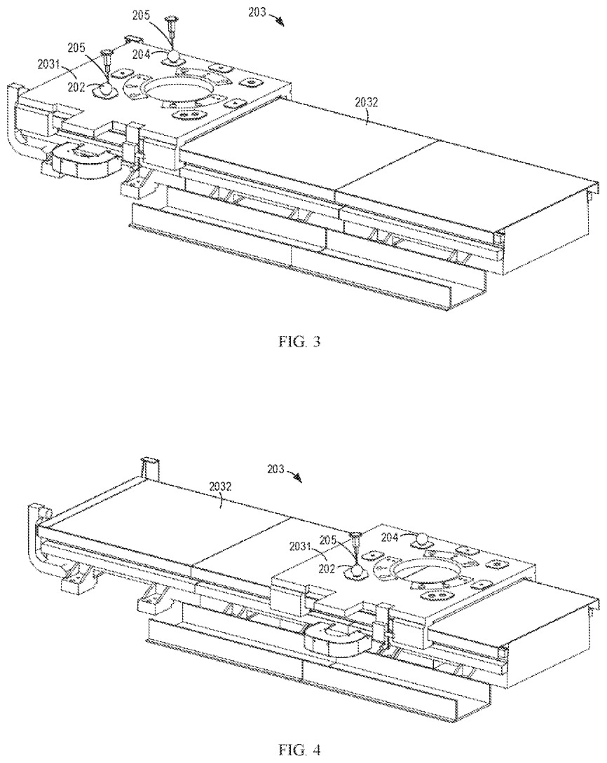

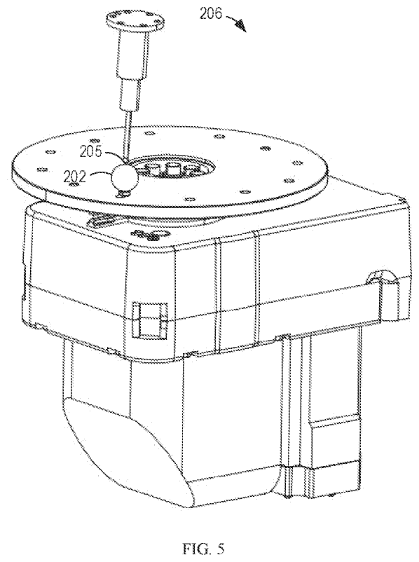

In some embodiments, the first reference object 202 may be a ball arranged on the external axis 201 dedicatedly for the method according to embodiments of the present disclosure. For example, FIGS. 3 and 4 show that the first reference objects 202 may be two balls arranged on a translational body 2031 of the translational worktable 203 sliding along a track 2032 thereof. FIGS. 5 and 6 show that the first reference object 202 may be a ball arranged on a turntable 206 rotating about its axis. In some alternative embodiments, the first reference object 202 may also be a hole, a recess or a protrusion originally formed on the external axis 201. In the following, the concept of the present disclosure will be discussed by taking the reference point being a centroid of a reference ball as shown in FIGS. 3-6 as an example. It should be understood that other situations are also similar, and will not be described separately in the following.

Example processes of how to implement the action as shown block 410 will be discussed with reference to FIGS. 3 to 6 by taking the basic types of the external axes 201, i.e., the translational worktable 203 and the turntable 206 as an example. In some embodiments, the sensor 205 may be controlled by the processing unit of the robot 200 to obtain a first set of positional data of the first reference point 2021 when the first reference point 2021 is at an original position, as shown in FIG. 3.

In some embodiments, to obtain the first set of positional data of the first reference point 2021, the sensor 205 may be control to move to a position away from the first reference object 202 by a certain distance and in a certain direction relative to the first reference object 202. For example, before obtaining the first set of the position date of the first reference point 2021, the sensor 205 may be moved to a predetermined position directly above the first reference object 202. This action may be achieved manually. For example, an operator may operate the robot 200 to move the sensor 205 to the predetermined position.

In some alternative embodiments, the sensor 205 may also be automatically moved to the predetermined position before obtaining the first set of the position date of the first reference point 2021. For example, the processing unit of the robot 200 may obtain the position of the first reference object 202 through an appropriate sensor such as a vision sensor, and move the sensor 205 to the position of the first reference object 202 without human interference.

To obtain the first set of positional data of the centroid of the first reference object 202, in some embodiments, the processing unit may control the sensor 205 to move along the surface of the first reference object 202 to obtain a plurality sets of surface data in the base coordinate system. The plurality sets of surface data are corresponding to a plurality of points on the surface of the first reference object 202. The surface data may be three-coordinate data of these points in the base coordinate system of the robot 200.

With the plurality sets of surface data, a reference shape may be fitted with suitable algorithms. Algorithms used for fitting may comprise but are not limited to: least squares algorithm, Random sample consensus (RANSAC), etc. The “least squares” algorithm is a form of mathematical regression analysis used to determine the line of best fit for a set of data, providing a visual demonstration of the relationship between the data points. Each point of data represents the relationship between a known independent variable and an unknown dependent variable.

RANSAC is an iterative method to estimate parameters of a mathematical model from a set of observed data that contains outliers, when outliers are to be accorded no influence on the values of the estimates. Therefore, it also can be interpreted as an outlier detection method. A basic assumption is that the data consists of “inliers”, i.e., data whose distribution can be explained by some set of model parameters, though may be subject to noise, and “outliers” which are data that do not fit the model. The outliers can come, for example, from extreme values of the noise or from erroneous measurements or incorrect hypotheses about the interpretation of data. RANSAC also assumes that, given a (usually small) set of inliers, there exists a procedure which can estimate the parameters of a model that optimally explains or fits this data.

The reference shape may be fitted with the plurality sets of surface data by using any one of the above mentioned algorithms or their combination. With the determined reference shape, the first set of positional data of the centroid of the reference shape in the base coordinate system may be determined.

In a case where the external axis 201 is a translational worktable 203 as shown in FIG. 3, after the first set of positional data of the first reference point 2021 has been obtained, the processing unit may control the translational body 2031 of the translational worktable 203 to slide a predetermined distance along the track 2032 thereof. Then the processing unit controls the robot 200 to move the sensor 205 to obtain a further set of positional data of the first reference point 2021 with the above mentioned method of determining the first set of positional data of the first reference point 2021, as shown in FIG. 4. In this way, two sets of positional data of the first reference point 2021 can be obtained. The above actions of moving the first reference object 202 and obtaining positional data of the reference point may be repeated to obtain more than two sets of positional data of the first reference point 2021.

For the translational worktable 203, at least two sets of position data of the reference point must be obtained before the next operation can be performed. However, for a turntable 206, at least three sets of position data of the reference point are necessary to proceed to the next step.

For example, in the case where the external axis 201 is a turntable 206, as shown in FIGS. 5 and 6, after the first set of positional data of the first reference point 2021 has been obtained, the processing unit may control the turntable 206 to rotate a predetermined angle about its axis. Then the processing unit controls the robot 200 to move the sensor 205 to obtain a further set of positional data of the first reference point 2021 with the above mentioned method of determining the first set of positional data of the first reference point 2021, as shown in FIG. 6. After that, the turntable 206 may be controlled to rotate a further predetermined angle about its axis in a direction the same as the first rotation. Then the processing unit controls the robot 200 to move the sensor 205 to obtain a further set of positional data of the first reference point 2021. In this way, at least three sets of positional data of the first reference point 2021 can be obtained.

In order to calibrate the external axis 201 more accurately, the predetermined distance and the predetermined angle as mentioned above can be set within a predetermined range. For example, the predetermined angle for each rotation of the turntable 206 may be greater than 45° and less than 180°, for example, 90° for each rotation. The predetermined distance for the translational worktable 203 is also preferably greater than ¼ of the total length of the track 2032. Of course, it should be understood that the illustrations of these angles and distances are merely illustrative, without suggesting any limitation as to the scope of the present disclosure. Any other suitable angle or distance is possible. In some embodiments, the predetermined angels for the multiple rotations of the turntable 206 or the predetermined distances for the multiple translations of the translational worktable 203 may also be different. For example, the predetermined angle for the first rotation may be 90° and the predetermined angle for the second rotation may be 45°.

Referring back to FIG. 2, after enough sets of positional data of the first reference point 2021 have been obtained, in block 420, the processing unit determines a transformation relationship between the base coordinate system and the user coordinate system of the external axis 201 according to the obtained positional data. The transformation relationship may comprise the distance deviation between the origins of the user coordinate system and the base coordinate system, and the angular deviation between the coordinate axes of the user coordinate system and the base coordinate system.

Because the first set of the position data is embodied as coordinate valves in the base coordinate system, if the first set of the position data of the first reference object 202 is set as the origin of the user coordinate system, the distance deviation between the origins of the user coordinate system and the base coordinate system can be determined. For the translational worktable 203 as shown in FIGS. 3 and 4, by taking the sliding direction of the translational body 2031 as an X axis of the user coordinate system, with the above obtained position data of the first reference point 2021, the angular deviation, which may be embodied by Euler Angles, between the coordinate axes of the user coordinate system and the base coordinate system can be determined. The Euler angles are three angles introduced by Leonhard Euler to describe the orientation of a rigid body with respect to a fixed coordinate system. Regarding the present disclosure, the angular deviation between the coordinate axes of the user coordinate system and the base coordinate system may be embodied by Euler Angles.

Specifically, in some embodiments, the processing unit may determine a reference straight line by fitting the at least two sets of positional data of the first reference point 2021. The fitting algorithm may use the algorithm mentioned above, for example, least squares algorithm. Random sample consensus (RANSAC) or there combination. The fitted reference straight line is substantially aligned with the sliding direction of the translational body 2031, i.e., the X axis of the user coordinate system. Since the reference straight line is fitted by the coordinate values, i.e., the obtained positional data in the base coordinate system, the functional representation of the fitted reference straight line can also be embodied in the base coordinate system. Thus, according to the fitted reference straight line, the Euler angle at least between the between the X axes of the user coordinate system and the base coordinate system can be determined. Furthermore, due to the fixed angle relationship between the XYZ axes of the coordinate system, Euler angles between the Y and Z axes of the user coordinate system and the base coordinate system can also be determined. In this way, for the translational worktable 203, the transformation relationship between the base coordinate system and the user coordinate system can be determined.

For the case where the external axis 201 is a turntable 206 as shown in FIGS. 5 and 6, by taking the rotation axis of the turntable 206 as a Z axis, with the above obtained position data of the first reference point 2021, a reference curved line, i.e., a circle, may be fitted by suitable algorithm, for example, least squares algorithm, Random sample consensus (RANSAC) or there combination. With the fitted circle, coordinate values of its center in the base coordinate system and a rotation axis passing through the center can be determined. In the case where the first reference point 2021 has a certain distance from the plane of the turntable 206, when a center of the plane of the turntable is set as an origin of the user coordinate system, the coordinate values of the origin of the user coordinate system in the base coordinate system can be determined according to the determined coordinate values of the center of the fitted circle and the certain distance between the first reference point 2021 and the plane of the turntable 206.

In this way; by taking the rotation axis of the turntable 206 as the Z axis, with the determined coordinate values of the center and the rotation axis, at least the angular deviation, which may be embodied by Euler Angles, between the Z axes of the user coordinate system and the base coordinate system can be determined. In this way, a chain between the user coordinate system and the base coordinate system can be established, i.e., the transformation relationship between the base coordinate system and the user coordinate system can be determined.

After the transformation relationship is determined, in block 430 as shown in FIG. 2, the calibrated user coordinate system can then be determined based on the base coordinate system and the transformation relationship. For example, the calibrated user coordinate system can be expressed by indicating the coordinate values of the origin of the user coordinate system in the base coordinate system and the angular deviations, which may be embodied by Euler Angles, between the coordinate axes of the user coordinate system and the base coordinate system. In this way, the chain between the user coordinate system and the base coordinate system can be established.

The above describes example processes of calibrating the translational worktable 203 and the turntable 206, as basic types of the external axes 201, with respect to the robot 200. It can be seen that the processes can be performed automatically by the robot 200. In comparison to the calibration processes manually performed by the operator, errors caused by human factors are eliminated, which can significantly improve the reliability of calibration.

Furthermore, according to the method of the present disclosure, an error range of the calibration can be determined with the line or curved line fitted according to the positional data of the first reference point 2021. For example, in some embodiments, after the reference line, including straight and curved lines as mentioned above, has been fitted, the processing unit may determine deviations between the at least two sets of positional data of the first reference point 2021 and the fitted reference line. Then the processing unit can determine the error range of the calibration according to the deviations.

That is, according to the method of the present disclosure, the error range of the calibration can be determined along with the automatic calibration of the external axis 201 relative to the robot 200. This error range can then be used to make decisions. For example, when it is determined that the determined error range, which can be determined by some analysis, is caused by the error of the external axis 201, the operator can maintain or replace the external axis 201 according to the error range to improve the accuracy of workpiece machined with the external axis 201.

Furthermore, the method according to embodiments of the present disclosure can be applied not only to the above-mentioned translational worktable 203 or turntable 206, but also to a positioner with any combination of at least one translational worktable 203 and/or at least one turntable 206. During the calibration of the positioner using the method according embodiments of the present disclosure, the positioner can be divided into multiple basic types of the external axes 200, i.e., the translational worktables 203 or turntables 206, as mentioned above.

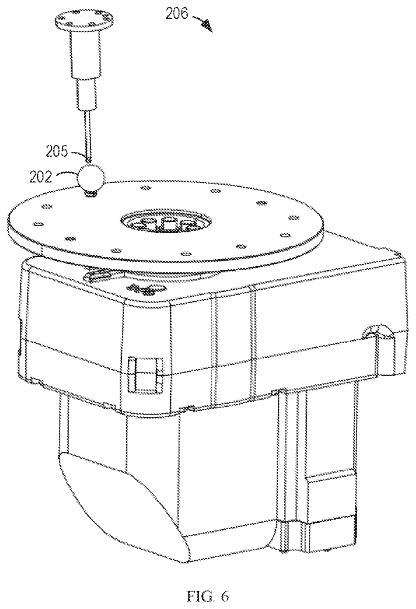

For example, FIG. 7 shows a simple positioner which comprises a translational worktable 203 and a turntable 206 arranged on the translational body 2031 of the translational worktable 203. When calibrating the positioner as shown in FIG. 7, the first user coordinate system of the translational worktable 203 may first be calibrated relative to the base coordinate system of the robot 200 according to the method as mentioned above. After the chain between the first user coordinate system and the base coordinate system has been established, the second user coordinate system of the turntable 206 may then be calibrated by establishing the chain between the first and second user coordinate systems.

In this way, no matter how complex the structure of positioner is, it can be divided into basic types such as the translational worktables 203 or turntables 206 as mentioned above. As a result, a positioner with a complex structure can be calibrated using the method according to embodiments of the present disclosure.

In some embodiments, more than one reference object and/or reference point may be used to determine the transformation relationship more accurately. For example, as shown in FIGS. 3 and 4, two reference objects, namely the first reference object 202 and the second reference object 204 are used. The two reference objects respectively have two reference points, i.e., centroids of the first reference object 202 and the second reference object 204. In some embodiments, the two reference objects can be arranged such that their connecting line is aligned with a coordinate axis, for example Y axis of the user coordinate system. With more than one reference objects, each of their reference points may be used to perform the above mentioned calibration method.

For example, after at least two sets of positional data of a first reference point 2021 are obtained, the processing unit may be further configured to obtain at least two sets of positional data of the second reference point 2041 of the second reference object 204. The processing unit can then determine a positional relationship between the first and second reference points in the user coordinate system.

For example, in some embodiments, when the two reference objects are placed or formed on the external axis 201, the positional relationship between the first and second reference points 2021, 2041 is determined according to their placement and has been stored in the memory. In this case, the processing unit only needs to retrieve the corresponding positional relationship from the memory.

In some alternative embodiments, the processing unit may also determine the positional relationship between the first and second reference points 2021, 2041 according to the at least two sets of positional data of the first reference point 2021 and the at least two sets of positional data of the second reference point 2041.

After the positional relationship between the first and second reference points 2021, 2041 is determined, the processing unit may determine the above mentioned transformation relationship between the user coordinate system and the base coordinate system according to the positional relationship, the at least two sets of positional data of the first reference point 2021 and the at least two sets of positional data of the second reference point 2041. In this way, the external axis 201 can be calibrated more accurately.

Furthermore, in some embodiments, with more than one reference point being used, each reference point can independently participate in the calibration process described above. The calibration process and results, i.e., the transformation relationships and/or the error ranges, using these reference points can be mutually verified to thereby improve the reliability of the calibration.

It is to be understood that the above embodiments where two reference objects and/or reference points are used for calibration are merely illustrative, without suggesting any limitation as to the scope of the present disclosure. Any other number of the reference objects and/or reference points may also be possible. For example, in some embodiments, three or more reference points may also be used for calibration of the external axis 201 relative to the robot 200.

Furthermore, the reference points are not necessary to be arranged such that the connecting line between them is aligned with a coordinate axis in the user coordinate system. As long as their positions are relatively fixed, any appropriate situation can be adopted for the positional relationship between them.

In some embodiments, the plurality of reference points may belong to one reference object. For example, in some embodiments, a cube may be used as the reference object. In this event, points at the corners of the cube may be used as the reference points. In other words, the reference point is not necessarily the centroid of the reference object, and it can be any appropriate point on the reference object.

Moreover, the method according to embodiments of the present disclosure can be used to calibrate the external axis 201 whenever the position of the external axis 201 relative to the robot 200 is changed, i.e., whenever the external axis 201 is displaced designedly or accidentally. The calibration results, for example the transformation relationship and/or determined error ranges as mentioned above of each calibration can be automatically recorded in the memory. In some embodiments, these records may also be transmitted to other external devices in the Internet of Things in a wired or wireless manner, so as to be used by these external devices to help improve the operability and accuracy of the robotic processing system including the robot 200 and one or more external axes 201.

For example, in some embodiments, the status of the robotic processing system can be analyzed through the historical calibration records. Through analysis, the transformation relationships and/or determined error ranges after multiple calibrations can be compared to determine whether the external axis 201 of the robotic processing system is worn or accidentally displaced.

In some embodiments, when the position of the external axis 201 relative to the robot 200 is changed by a predetermined distance in a predetermined direction, the new transformation relationship can be determined according to the old transformation relationship and the predetermined distance and direction. The new transformation relationship indicates the transformation relationship between the base coordinate system and the user coordinate system after the movement of the external axis 201 relative to the robot 200. The old transformation relationship indicates the transformation relationship between the base coordinate system and the user coordinate system before the movement of the external axis 201 relative to the robot 200. “The position of the external axis 201 relative to the robot 200 being changed” herein means the displacement of the external axis 201 relative to the robot 200. For example, for the translational worktable 203, the displacement of the external axis 201 means the whole translational worktable 203 including the translational body 2031 and the track 2032 is displaced relative to the robot 200.

That is to say; when the displacing distance and direction of the external axis 201 relative to the robot 200 can be determined, the above-mentioned method may not be used for re-calibration, but only the new transformation relationship can be determined according to the movement distance, the movement direction and the old transformation relationship, which may significantly improve the efficiency of the calibration.

Moreover, the automatic calibration method according to embodiments of the present disclosure can also be used to confirm the status of the robotic processing system. For example, during the maintenance of the robotic processing system, even if there is no known displacement of the external axis 201 relative to the robot 200, the processing unit may perform the above automatic calibration method periodically to determine whether the newly determined transformation relationship and/or error range is changed relative to the previously determined one. This can improve the reliability of the maintenance.

Referring back to FIG. 2, after the user coordinate system of the external axis 201 has been calibrated relative to the base coordinate system of the robot 200, in block 440, the processing unit can then control the robot 200 to process an object or a workpiece arranged on the external axis 201 under the calibrated user coordinate system. Before that, some necessary acts may also be performed. For example, the sensor 205 arranged on the end of the robot 200 may be changed to an end effector to process the object. For example, in some embodiments, an object coordinate system of the object to be processed and the chain between the object coordinate system or other suitable coordinate system in the robotic processing system may be established.

It can be seen from the above that whole calibration processes of the external axis 201 relative to the robot 200 using the method disclosed herein do not require an operator to have much background knowledge. The operator only needs to control the robot to move the sensor to a predetermined position before calibration without other operations. This reduces the demand for operators and therefore reduces the cost of employment.

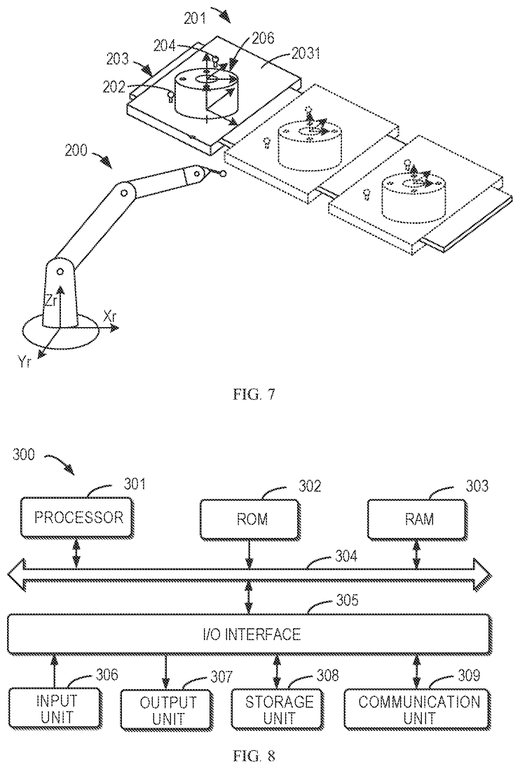

FIG. 8 shows a block diagram of an example computing system/device 300 suitable for implementing example embodiments of the present disclosure. The system/device 300 can be implemented as or implemented in above mentioned processing unit of the robot. The system/device 300 may be a general-purpose computer, a physical computing device, or a portable electronic device, or may be practiced in distributed cloud computing environments where tasks are performed by remote processing devices that are linked through a communication network. The system/device 300 can be used to implement the process 400 of FIG. 2.

As depicted, the system/device 300 includes a processor 301 which is capable of performing various processes according to a program stored in a read only memory (ROM) 302 or a program loaded from a storage unit 308 to a random access memory (RAM) 303. In the RAM 303, data required when the PROCESSOR 301 performs the various processes or the like is also stored as required. The PROCESSOR 301, the ROM 302 and the RAM 303 are connected to one another via a bus 304. An input/output (I/O) interface 305 is also connected to the bus 304.

The processor 301 may be of any type suitable to the local technical network and may include one or more of the following: general purpose computers, special purpose computers, microprocessors, digital signal processors (DSPs), graphic processing unit (GPU), co-processors, and processors based on multicore processor architecture, as non-limiting examples. The system/device 300 may have multiple processors, such as an application-specific integrated circuit chip that is slaved in time to a clock which synchronizes the main processor.

A plurality of components in the system/device 300 are connected to the I/O interface 305, including an input unit 306, such as a keyboard, a mouse, or the like: an output unit 307 including a display such as a cathode ray tube (CRT), a liquid crystal display (LCD), or the like, and a loudspeaker or the like: the storage unit 308, such as a disk and optical disk, and the like; and a communication unit 309, such as a network card, a modem, a wireless transceiver, or the like. The communication unit 309 allows the system/device 300 to exchange information/data with other devices via a communication network, such as the Internet, various telecommunication networks, and/or the like.

The methods and processes described above, such as the process 400, can also be performed by the processor 301. In some embodiments, the process 400 can be implemented as a computer software program or a computer program product tangibly included in the computer readable medium, e.g., storage unit 308. In some embodiments, the computer program can be partially or fully loaded and/or embodied in the system/device 300 via ROM 302 and/or communication unit 309. The computer program includes computer executable instructions that are executed by the associated processor 301. When the computer program is loaded to RAM 303 and executed by the processor 301, one or more acts of the process 200 described above can be implemented. Alternatively, processor 301 can be configured via any other suitable manner (e.g., by means of firmware) to execute the process 200 in other embodiments.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of the example embodiments of the present disclosure are illustrated and described as block diagrams, flowcharts, or using some other pictorial representations, it will be appreciated that the blocks, apparatuses, systems, techniques, or methods described herein may be implemented in, as non-limiting examples, hardware, software, firmware, special purpose circuits or logic, general purpose hardware or controller or other computing devices, or some combination thereof.

The present disclosure also provides a computer readable storage medium having computer readable program instructions stored thereon which, when executed by a processing unit, cause the processing unit to perform the methods/processes as described above. A computer readable storage medium may include but is not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

In this way, the computer readable program instructions for carrying out the method of calibrating an external axis 201 relative to a robot 200 according to embodiments can be copied to and used by any suitable robot or device which has a processing unit and a sensor. In this way, initial installation cost and time of the robotic processing system can be significantly reduced.

Computer readable program instructions for carrying out methods disclosed herein may be written in any combination of one or more programming languages. The program instructions may be provided to a processor or controller of a general purpose computer, special purpose computer, or other programmable data processing apparatus, such that the program instructions, when executed by the processor or controller, cause the functions/operations specified in the flowcharts and/or block diagrams to be implemented. The program instructions may execute entirely on a computer, partly on the computer, as a stand-alone software package, partly on the computer and partly on a remote computer or entirely on the remote computer or server. The program instructions may be distributed on specially-programmed devices which may generally be referred to herein as “modules”.

While operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

It should be appreciated that the above detailed embodiments of the present disclosure are only for exemplifying or explaining principles of the present disclosure and do not limit the present disclosure. Therefore, any modifications, equivalent alternatives and improvements, etc. without departing from the spirit and scope of the present disclosure shall be comprised in the scope of protection of the present disclosure. Meanwhile, appended claims of the present disclosure aim to cover all the variations and modifications falling under the scope and boundary of the claims or equivalents of the scope and boundary.

1. A method of manipulating a robot, comprising:
obtaining at least two sets of positional data of a first reference point in a base coordinate system of the robot, the first reference point fixedly arranged on the external axis, the at least two sets of positional data corresponding to at least two positions of the first reference point during movement of the external axis;
determining a transformation relationship between the base coordinate system and an user coordinate system of the external axis according to the at least two sets of positional data;
determining the calibrated user coordinate system based on the base coordinate system and the transformation relationship; and
controlling the robot to process an object arranged on the external axis under the calibrated user coordinate system.

2. The method of claim 1, wherein obtaining the at least two sets of positional data comprises:
obtaining a first set of positional data of the first reference point with a sensor arranged on the robot when the first reference point is at an original position; and
obtaining at least one set of positional data of the first reference point corresponding to at least two moving positions of the first reference point during the movement of the external axis.

3. The method of claim 1, wherein determining the transformation relationship comprises:
determining a reference line by fitting the at least two sets of positional data of a first reference point; and
determining the transformation relationship according to the reference line and the base coordinate system.

4. The method of claim 3, further comprising:
determining deviations between the at least two sets of positional data of a first reference point and the reference line; and
determining an error range of calibration according to the determined deviations.

5. The method of claim 1, wherein determining the transformation relationship further comprises:
obtaining at least two sets of positional data of a second reference point fixedly arranged on the external axis in the base coordinate system, the at least two sets of positional data corresponding to at least two positions of the second reference point during movement of the external axis;
determining a positional relationship between the first reference point and the second reference point in the user coordinate system; and
determining the transformation relationship according to the positional relationship, the at least two sets of positional data of the first reference point and the at least two sets of positional data of the second reference point.

6. The method of claim 1, wherein obtaining the at least two sets of positional data further comprises:
obtaining a plurality sets of surface data corresponding to a plurality of points on a surface of a reference object where the reference point is located;
determining a reference shape by fitting the plurality sets of surface data; and
obtaining one of the at least two sets of positional data according to the determined reference shape.

7. The method of claim 6, wherein the reference object comprises at least one of a ball, a cylinder, a hole or polyhedron formed on or fixedly arranged on the external axis.

8. The method of claim 1, wherein the external axis comprises at least one of a translational worktable or a turntable, or a combination thereof.

9. An electronic device, comprising:
at least one processing unit; and
at least one memory coupled to the at least one processing unit and storing instructions which, when executed by the at least one processing unit, causing the at least one processing unit to:
obtain at least two sets of positional data of a first reference point in a base coordinate system of the robot, the first reference point fixedly arranged on the external axis, the at least two sets of positional data corresponding to at least two positions of the first reference point during movement of the external axis;
determine a transformation relationship between the base coordinate system and an user coordinate system of the external axis according to the at least two sets of positional data;
determine the calibrated user coordinate system based on the base coordinate system and the transformation relationship; and
control the robot to process an object arranged on the external axis under the calibrated user coordinate system.

10. The electronic device of claim 9, wherein the at least one processing unit is further configured to:
obtain a first set of positional data of the first reference point with a sensor arranged on the robot when the first reference point is at an original position; and
obtain at least one set of positional data of the first reference point corresponding to at least two moving positions of the first reference point during the movement of the external axis.

11. The electronic device of claim 9, wherein the at least one processing unit is further configured to:
determine a reference line by fitting the at least two sets of positional data of a first reference point; and
determine the transformation relationship according to the reference line and the base coordinate system.

12. The electronic device of claim 11, wherein the at least one processing unit is further configured to:
determine deviations between the at least two sets of positional data of a first reference point and the reference line; and
determine an error range of calibration according to the determined deviations.

13. The electronic device of claim 9, wherein the at least one processing unit is further configured to:
obtain at least two sets of positional data of a second reference point fixedly arranged on the external axis in the base coordinate system, the at least two sets of positional data corresponding to at least two positions of the second reference point during movement of the external axis;
determine a positional relationship between the first reference point and the second reference point in the user coordinate system; and
determine the transformation relationship according to the positional relationship, the at least two sets of positional data of the first reference point and the at least two sets of positional data of the second reference point.

14. The electronic device of claim 9, wherein the at least one processing unit is further configured to:
obtain a plurality sets of surface data corresponding to a plurality of points on a surface of a reference object where the reference point is located;
determine a reference shape by fitting the plurality sets of surface data; and
obtain one of the at least two sets of positional data according to the determined reference shape.

15. The electronic device of claim 14, wherein the reference object comprises at least one of a ball, a cylinder, a hole or polyhedron formed on or fixedly arranged on the external axis.

16. The electronic device of claim 9, wherein the external axis comprises at least one of a translational worktable or a turntable, or a combination thereof.

17. A computer readable storage medium having computer readable program instructions stored thereon which, when executed by a processing unit, cause the processing unit to perform the method of claim 1.

18. The computer readable storage medium of claim 17,
wherein, in the method, the obtaining the at least two sets of positional data comprises:
obtaining a first set of positional data of the first reference point with a sensor arranged on the robot when the first reference point is at an original position; and
obtaining at least one set of positional data of the first reference point corresponding to at least two moving positions of the first reference point during the movement of the external axis.

19. The computer readable storage medium of claim 17,
wherein, in the method, the determining the transformation relationship comprises:
determining a reference line by fitting the at least two sets of positional data of a first reference point; and
determining the transformation relationship according to the reference line and the base coordinate system.

20. The computer readable storage medium of claim 17,
wherein, in the method, the determining the transformation relationship further comprises:
obtaining at least two sets of positional data of a second reference point fixedly arranged on the external axis in the base coordinate system, the at least two sets of positional data corresponding to at least two positions of the second reference point during movement of the external axis;
determining a positional relationship between the first reference point and the second reference point in the user coordinate system; and
determining the transformation relationship according to the positional relationship, the at least two sets of positional data of the first reference point and the at least two sets of positional data of the second reference point.
